(19) United States
(12) Patent Application Publication
(10) Pub. No.: US 2024/0329781 A1
(43) Pub. Date: Oct. 3, 2024

(54) DEVICE PERFORMANCE ENHANCEMENT BASED ON USER GRIP

(71) Applicant: Microsoft Technology Licensing, LLC, Redmond, WA (US)

(72) Inventors: Eli BAREL, RoshHaayin (IL); Roy Gan MAIBERGER, Kiryat Ono (IL)

(21) Appl. No.: 18/295,089

(22) Filed: Apr. 3, 2023

(51) Int. Cl. G06F 3/042; G06F 3/043; G06F 3/04817

(52) U.S. Cl. CPC G06F 3/0428; G06F 3/043; G06F 3/04817

(57) ABSTRACT

Device performance is enhanced by adapting device and/or component configurations to user grip, lack thereof, and/or a particular user grip type. User grip may be determined based on analyses of motion, chassis touch, and/or screen touch. A chassis touch analysis may be performed with or without generating acoustic waves to detect palm and finger placement near speakers and/or microphones. The chassis touch analysis may be implemented alone or in conjunction with a touch screen analysis for a more complete understanding of user grip. User grip may be matched with a suitable grip configuration for the device or components thereof. A no touch configuration may increase device productivity since the device temperature may rise without user contact. A screen bezel touch configuration may reconfigure displayed icons to avoid unintentional selection.

### BACKGROUND

Many computing devices today have touchscreens, including desktop computers, laptops, tablets, handheld game consoles, e-readers, and smart phones. Such touchscreen computing devices have increasingly narrow bezels to maximize the amount of display area of the touch screen. Thus, a user using a touchscreen computing device may contact the touchscreen while gripping or manipulating the computing device, such as when positioning the computing device, opening or closing a stand of the computing device, holding the computing device with one hand while scrolling with the other hand, or holding a computing device to take a photo.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein enable device (e.g., computing device) performance enhancements based on user grip. Device performance is controlled by adaptation of device or component configurations to detected user grip. The device may detect that a user is or is not gripping a device and/or may detect a particular user grip type being applied to the device by the user. A user grip presence and/or type may be determined based on analyses of motion, chassis touch, and/or screen touch. The chassis touch analysis may be performed using multiple modes with or without generating acoustic waves through speakers to detect palm and finger placement near speakers and/or microphones. A chassis touch analysis may be implemented alone or in conjunction with a touch screen analysis for a more complete understanding of user grip. A determined user grip may be matched with a suitable grip configuration for the device or one or more components thereof. For example, a no touch configuration may increase device productivity because the device temperature may rise without user contact. A screen bezel touch configuration may reconfigure displayed icons to avoid unintentional selection. Furthermore, grip detection may be triggered to conserve power.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example system for performance enhancement based on user grip, in accordance with an example embodiment.

FIG. 2 shows a block diagram of an example system for performance enhancement based on user grip, in accordance with an example embodiment.

FIGS. 3A-3F show examples of detecting different user grip types, in accordance with embodiments.

FIG. 4 shows a flowchart of a process for implementing performance enhancement based on user grip, in accordance with an embodiment.

FIG. 5 shows a flowchart of a process for implementing performance enhancement based on user grip, in accordance with an embodiment.

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As set forth in the Background section, touchscreen computing devices have increasingly narrow bezels, which may lead to unintentional contact with the touchscreens while gripping or manipulating the computing devices, such as when positioning a computing device, opening or closing a stand of the computing device, holding the computing device with one hand while scrolling with the other hand, or holding the computing device to take a photo. Such unintentional contact with a touchscreen may be misinterpreted by a computing device as intentional contact, and thus the computing device may apply digital inking to the contacted area, invoke an application icon in the contacted area, or perform other unintended operation. Furthermore, computing device performance may be limited based on a detected or estimated surface temperature of the computing device that may come in contact with a user.

As such, methods, systems, and computer program products are disclosed herein for enabling device performance enhancements based on user grip. Device performance is controlled and improved by adaptation of device or component configurations to detected user grip. The device may detect that a user is or is not gripping a device and/or may detect a particular user grip type (e.g., grip style, grip position, grip side). User grip may be determined based on analyses of motion (e.g., indicated by accelerometer or gyro), chassis touch (e.g., indicated by microphone(s)), and/or screen touch (e.g., indicated by digitizer). A chassis touch analysis may be performed using multiple modes with or without generating acoustic waves through speakers to detect palm and finger placement near speakers and/or microphones. Therefore, a grip placement and/or a grip type may be determined in embodiments based on standard hardware present in many computing devices without the need for additional components (e.g., sensors, surface acoustic wave generators) that may increase cost and/or require device redesign. The chassis touch analysis may be implemented alone or in conjunction with a touch screen analysis for a more complete understanding of user grip. User grip may be matched with a suitable grip configuration for the device or one or more components thereof. For example, a no touch configuration may increase device productivity since the device temperature may rise without user contact. A screen bezel touch configuration may reconfigure displayed icons to avoid unintentional selection, which increases device and user productivity (by reducing the need to close unintentionally invoked applications). Furthermore, grip detection may be triggered (e.g., based on motion of input detection) for various reasons, including to conserve device power, thereby preserving battery life and reducing the need for recharging.

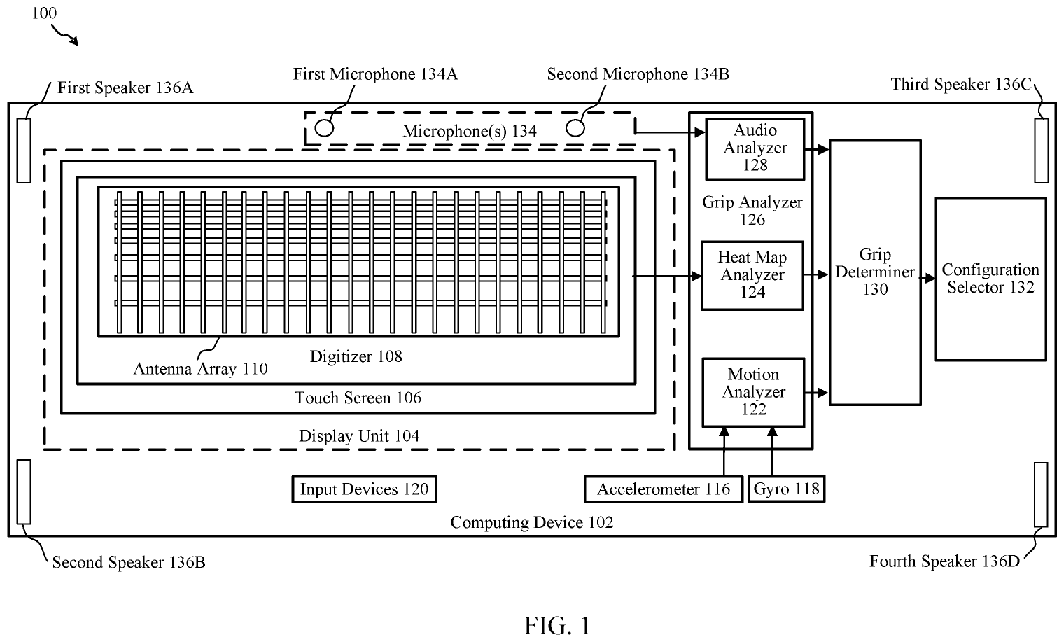

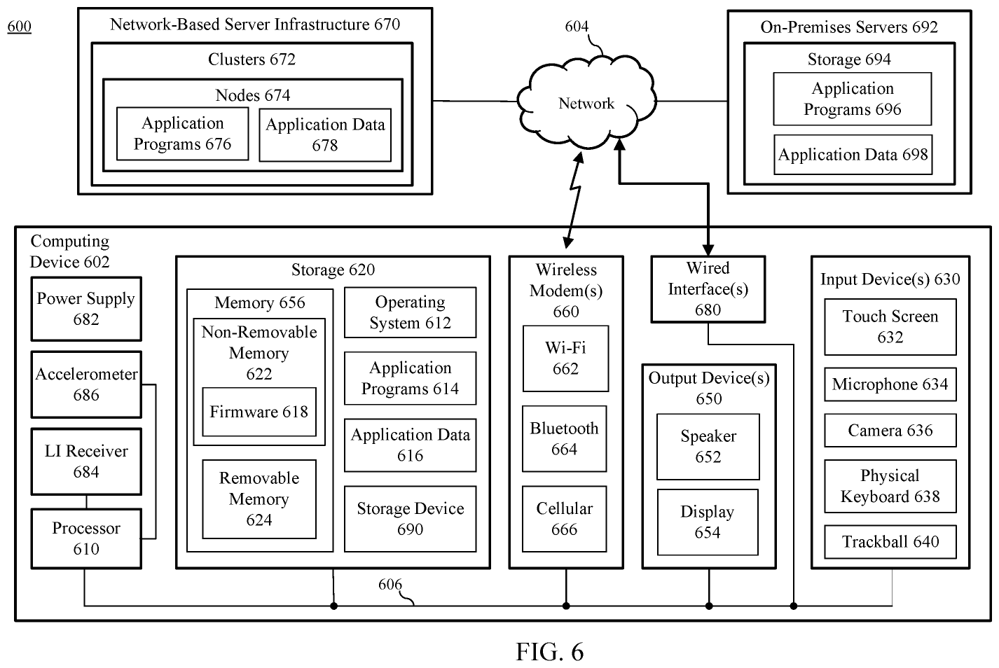

Embodiments may be configured in various ways in various embodiments. For instance, FIG. 1 shows a block diagram of an example system for performance enhancement based on user grip, in accordance with an example embodiment. A computing environment may be any computing environment (e.g., any combination of hardware, software, and firmware). An example computing device with example features is presented in FIG. 6.

As shown in FIG. 1, example computing environment 100 includes a computing device 102. Computing device 102 includes a display unit 104, which includes a touch screen 106, a digitizer 108, and an antenna array 110, one or more additional sensors, such as an accelerometer 116 and a gyro 118, one or more input devices 120 (e.g., keyboard, mouse, trackpad), a grip analyzer 126, a grip determiner 130, and a configuration selector 132. Grip analyzer 126 includes a heat map analyzer 124, an audio analyzer 128, and a motion analyzer 122. Grip analyzer 126, grip determiner 130, and configuration selector 132 form a grip configuration system for computing device 102. These components of example computing environment 100 are described in further detail as follows.

Computing device 102 may be any type of stationary or mobile computing device that a user may grip, including a mobile computer or mobile computing device described herein or otherwise known, such as a Microsoft® Surface® device, a personal digital assistant (PDA), a laptop computer, a notebook computer, a tablet computer such as an Apple iPad™, a smart phone (such as an Apple® iPhone®, a phone implementing the Google® Android™ operating system), a wearable computing device (e.g., a head-mounted device including smart glasses such as Google® Glass™, a virtual headset such as Oculus Quest 2® by Reality Labs, a division of Meta Platforms, Inc. or HoloLens® by Microsoft Corporation), or a stationary computing device such as a server, or a desktop computer or PC (personal computer). Computing device 102 may include one or more applications, operating systems, virtual machines (VMs), storage devices, etc., that may be executed, hosted, and/or stored therein or via one or more other computing devices via network(s) (not shown).

Computing device 102 may execute one or more processes. A process is any type of executable (e.g., binary, program, application) that is being executed by a computing device. A process may include one or more of grip analyzer 126, grip determiner 130, configuration selector 132, and/or components thereof. A process may be executed by a variety of processors, such as a central processing unit (CPU), a microcontroller, etc. Computing device (e.g., touch device) 102 may be configured to execute software applications that cause content to be displayed to users via display unit 104. Computing device 102 may also be configured to display content generated by remotely executed software applications.

Computing device may include a variety of transducers and sensors. For example, computing device may include first, second, third, and fourth speakers 136A-136D, first and second microphones 134A-134B, accelerometer 116, gyroscope 118, and so on. Computing device 102 may include a variety of input devices, such as touch screen 106, a keyboard, a mouse, a trackpad, a digital stylus/pen, and so on. These and/or further types of transducers, sensors, and input devices of computing device 102 may be disclosed and/or described elsewhere herein (e.g., with respect to FIG. 6). As described herein, signals generated by the transducers, sensors, and input devices associated with computing device 102 may be analyzed to determine user grip, which may in turn be used to select an operating configuration appropriate to the determined grip.

Display unit 104 displays imagery to a user, such as selectable icons, applications, and so on. Display unit 104 includes touch screen 106 as an input device for user input (e.g., by touch and/or use of a stylus). Touch screen 106 may include an integrated touch interface (e.g., touch screen or touch pad) or a peripheral touch interface. Touch screen 106 includes antenna array 110 (e.g., a two-dimensional array of antenna elements/electrodes). Touch screen 106 may be utilized by users by hand gestures and/or through interaction with touch instruments, such as stylus, e.g., to perform inking operations. Digitizer 108 may include a touch controller (TC) (e.g., a microcontroller) to process (e.g., at least in part) signals generated by antenna array 110, e.g., in response to user interaction with touch screen 106.

Antenna array 110 is a sensor layer that includes a two-dimensional array of antenna elements/electrodes. Antenna array 110 may detect touch-related operations with contact (e.g., zero (0) hover height) or without contact (e.g., hover height>0). Antenna array 110 may detect interactions and communications (e.g., commands and/or information) associated with a stylus. For example, antenna array 110 may be configured to receive/transmit communication signals from/to a stylus. Antennas (e.g., electrodes) in antenna array 110 may detect (e.g., via electrostatic coupling), hand grips, hand gestures and operations using a stylus. Antenna array 110 may detect energy in a variety of forms and sources, such as wirelessly transmitted signals conveying information. Digitizer 108 may receive and process signals indicative of intentional and unintentional interactions and communications (e.g., commands and/or information) via touch screen 106, for example, to determine whether and/or where to implement inking operations, erasing operations, provide feedback, etc. Digitizer 108 may determine interactions and communications by processing energy detected by antenna array 110.

Digitizer 108 may include a processor (e.g., a microcontroller) configured to execute one or more processes. For example, digitizer 108 (e.g., a digitizer processor or TC, such as a microcontroller executing one or more processes) may be configured to determine whether to process signals and/or whether to provide signals to the operating system of computing device 102, e.g., based on whether the signals are interpreted to be intentional or unintentional touching of touch screen 106. In some examples, digitizer 108 may rely on the OS associated with computing device 102 to determine whether touching is intentional or unintentional. Digitizer 108 may selectively process, and/or selectively provide signals to an OS associated with computing device 102, for example, depending whether touch signals are related to touching deemed intentional or unintentional.

Digitizer 108 may operate based on a grip configuration selected by configuration selector 132. A grip configuration selected based on user grip may be applicable to digitizer 108, an operating system, one or more applications, and/or other components of device 102. As shown by example in FIG. 1, a grip configuration may be selected as follows: grip analyzer 126 may perform a grip analysis based on one or more transducers, sensors, and/or user inputs, grip determiner 130 may perform a grip determination based on data generated by the one or more analyses, and configuration selector 132 may select a grip configuration based on the determined user grip. The determined user grip may indicate a user is not gripping computing device 102, that the user is gripping computing device 102, and/or the type or category of grip. A type/category of grip may be associated with one or more grip configurations for one or more components of computing device, e.g., digitizer, operating system, application(s), grip analyzer 126, and so on.

For example, digitizer 108 (e.g., digitizer processor or TC) may determine whether and/or how to process touch signals generated by antenna array 110 based on the determined grip and/or based on a current or updated user grip configuration. A grip determination may begin with grip analyzer 126. Grip analyzer 126 may include, for example, heat map analyzer 124, audio analyzer 128, and motion analyzer 122.

Heat map analyzer 124 may process signals generated by antenna array 110 (e.g., a heat map that indicates electrical signal magnitudes across the two-dimensional array of electrodes of antenna array 110) continuously, periodically, or based on a trigger, such as a detection of motion or user input. Heat map analyzer 124 may provide grip determiner 130 with an indication of whether and/or where a user's hand touches areas of touch screen 106. Grip determiner 130 may determine the grip type (e.g., or lack of grip) based on the indication provided by heat map analyzer 124 alone or in combination with an indication provided by audio analyzer 128 and/or an indication provided by motion analyzer 122. Grip analyzer 126 may be configured to use heat map analyzer 124, audio analyzer 128, and/or motion analyzer 122.

Audio analyzer 128 may analyze signals generated by microphone(s) 134, e.g., first microphone 134A and/or second microphone 134B, based on noise and/or sound waves generated by speaker(s) 136 (e.g., first, second, third, and/or fourth speakers 134A-134D). Audio analyzer 128 may have multiple modes. A first mode may be a transmit-receive mode. A second mode may be a listen mode. In the first mode, speaker(s) 136 may drive an acoustic wave and microphone(s) 134 may detect the acoustic waves. As such, grip analyzer 126 is enabled to perform grip detection using standard computing device components (speakers, microphones) rather than needing dedicated sensors. In some examples, each speaker may drive the same wave at different times (e.g., based on a delay between transmissions). In this manner, the output of each speaker may be distinguished by grip analyzer 126 by time of broadcast and/or receipt (by microphone(s), without interference from other speaker output, and analyzed with greater accuracy. In some examples, each speaker may simultaneously drive an acoustic wave with a different frequency. In this manner, the output of each speaker may be distinguished by grip analyzer 126 by frequency of broadcast, without same frequency interference from other speakers, and analyzed with greater accuracy. In the second mode, speaker(s) 136 may not be used. Microphone(s) 134 may listen for noise. Signals generated by microphone(s) 134 based on acoustic waves or noise may indicate the presence or absence of user's palms and/or fingers relative to the chassis of computing device 102.

Motion analyzer 122 may analyze signals generated by accelerometer 116 and/or gyro 118. Motion analyzer 122 may generate one or more indications regarding position, orientation, velocity, and acceleration of computing device 102. Motion information may assist with a grip determination and/or may be used to trigger a grip determination.

Grip determiner 130 may receive a chassis touch indication from audio analyzer 128, a screen touch indication from heat map analyzer 124, and/or a motion indication from motion analyzer 122. In embodiments, grip determiner 130 may make a grip determination based on input from any one of audio analyzer 128, heat map analyzer 124, or motion analyzer 122. However, a grip determination by grip determiner 130 based on inputs of two or more of audio analyzer 128, heat map analyzer 124, motion analyzer 122 may provide a more complete understanding of grip. For example, a confirmation of a same grip type by input of both of audio analyzer 128 (via sound) and heat map analyzer 124 (via touch screen) may provide a more reliable grip type determination (e.g., reinforce each other) compared to a grip type determined by input from audio analyzer 128 alone. Having a more reliable grip type determination enables the grip configuration system of FIG. 1 to more reliably select a grip configuration (via configuration selector 132) that improves user experience in handling computing device 102. Grip determiner 130 may generate and provide a grip determination to configuration selector 132. For example, grip determiner 130 may compare measured/signal data to empirical data to determine a user grip type. In some examples, grip determiner 130 may apply input data received from audio analyzer 128, heat map analyzer 124, and/or motion analyzer 122 to a machine learning (ML) model or a look up table (LUT) to predict or identify a user grip.

Configuration selector 132 may receive a grip determination from grip determiner 130. Configuration selector 132 may use the grip determination to select a grip configuration (e.g., a process, an algorithm, a model, a set of parameters, a look up table, and so on) suitable for the user grip. A grip configuration may be applicable to one or more components of computing device 102. For example, digitizer 108 and/or the OS may use the grip determination and/or the associated grip configuration to determine whether and/or how to proceed with processing signals generated by antenna array 110.

For example, a determined grip and/or associated grip configuration indicating that the user is gripping a portion of the touch screen may cause digitizer 108 to add/or change portions of the heat map that are not processed to determine user input. For example, a grip configuration for digitizer may block out a portion of antenna array 100 or a heat map from user input processing.

For example, a determined grip and/or associated grip configuration indicating that the user is gripping a portion of the touch screen may (e.g., also) cause the OS to reconfigure, rearrange, or relocate displayed selectable icons, for example, to avoid accidental selection in the vicinity of where a user is touching touchscreen 106.

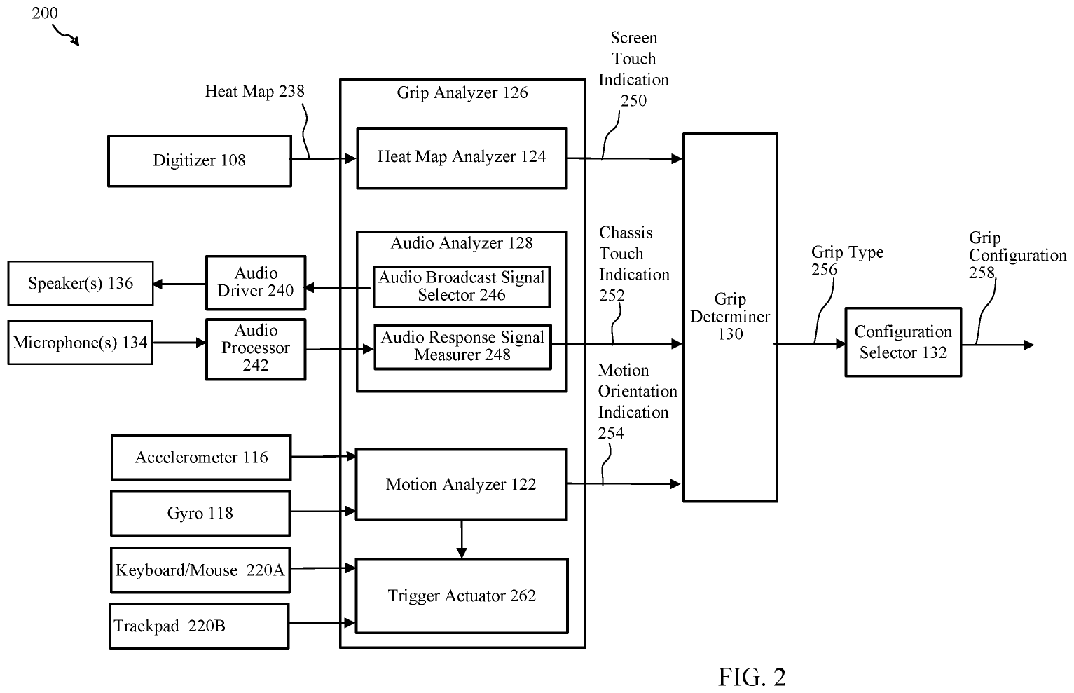

FIG. 2 shows a block diagram of an example grip configuration system 200 for performance enhancement based on user grip, in accordance with an example embodiment. FIG. 2 shows one of many example implementations of a grip configuration system 200.

As shown in FIG. 2, example grip configuration system 200 includes sensors and transducers (e.g., digitizer 108, speaker(s) 136, microphone(s) 134, accelerometer 116 and gyro 118), input devices (e.g., a keyboard and mouse 220A, a trackpad 220B), an audio driver 240, an audio processor 242, a grip analyzer 126, a grip determiner 130, and a configuration selector 132. These components of example grip configuration system 200 are described in further detail as follows.

Digitizer 108 may digitize touch input on a touch screen 106, which may or may not include user grip touch. Digitizer 108 may generate a heat map 238 that is a two-dimensional data structure that indicates electrical signal magnitudes for electrodes throughout the two-dimensional array of electrodes of antenna array 110. Digitizer 108 may be configured to determine whether to process touch input signals and/or whether to provide touch input or processed signals (e.g., heat map 238) to the operating system of computing device 102, e.g., based on whether the raw or processed touch signals are interpreted to be intentional or unintentional touching of touch screen 106. In some examples, digitizer 108 may rely on the OS (operating system) associated with computing device 102 to determine whether touching is intentional or unintentional. Digitizer 108 may selectively process, and/or selectively provide signals to an OS associated with a computing device 102, for example, depending whether touch signals are related to touching deemed intentional or unintentional.

Digitizer 108 may operate based on a grip configuration 258 selected by configuration selector 132. A grip configuration 258 selected based on user grip may be applicable to digitizer 108, an operating system, one or more applications, and/or other components of device 102. As shown by example in FIG. 2, a grip configuration may be selected as follows: grip analyzer 126 may perform a grip analysis based on one or more transducers, sensors, and/or user inputs, grip determiner 130 may perform a grip determination based on data generated by the one or more analyses, and configuration selector 132 may select a grip configuration based on the determined user grip. The determined user grip may indicate a user is not gripping computing device 102, that the user is gripping computing device 102, and/or the type or category of user grip. A type/category of user grip may be associated with one or more grip configurations 258 for one or more components of computing device, e.g., digitizer 108, operating system, application(s), grip analyzer 126, and so on.

For example, digitizer 108 may determine whether and/or how to process touch input signals generated by antenna array 110 based on the determined grip and/or based on a current or updated user grip configuration 258. A grip determination may begin with grip analyzer 126. Grip analyzer 126 may include, for example, heat map analyzer 124, audio analyzer 128, motion analyzer 122, and trigger actuator 262.

Trigger actuator 262 may trigger one or more grip analyses by grip analyzer 126. Trigger actuator 262 may conserve energy by limiting the operation of grip analyzer 126 to conditions when a user may be using computing device 102. Grip analyzer 126 may periodically operate (e.g., based on a timer or monitoring a clock) in addition to or alternative to being triggered by trigger actuator 262. For example, trigger actuator 262 may monitor user input devices, such as keyboard/mouse 220A and/or trackpad 220B for activity (e.g., button presses). Trigger actuator 262 may monitor computing device 102 for motion, which may be indicated by analysis of signals generated by accelerometer 116 and/or gyro 118. Motion analysis may be performed by motion analyzer 122. In an example, a user holding a closed computing device 102 would indicate motion, which may cause trigger actuator 262 to signal grip analyzer 126. A button press on the keyboard or mouse 220A or trackpad 220B (e.g., with computing device 102 resting on a desk) may cause trigger actuator 262 to signal grip analyzer 126. For example, a motion indication based on a signal generated by accelerometer 116 and/or gyro 118 may indicate motion if a user picked up computing device 102, walks with computing device 102 open or closed in a bag.

Grip analyzer 126 may be configured to (e.g., selectively) request analyses by heat map analyzer 124, audio analyzer 128, and/or motion analyzer 122, for example, based on a configuration, a type of trigger, and/or other information, such as whether computing device 102 is open, closed, in active or low power state, etc.

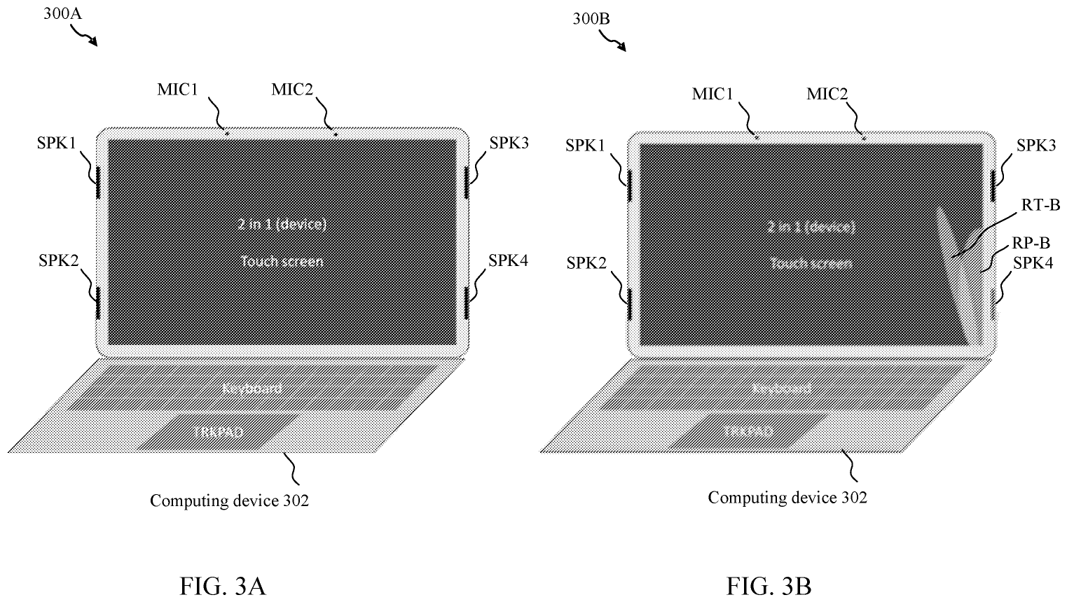

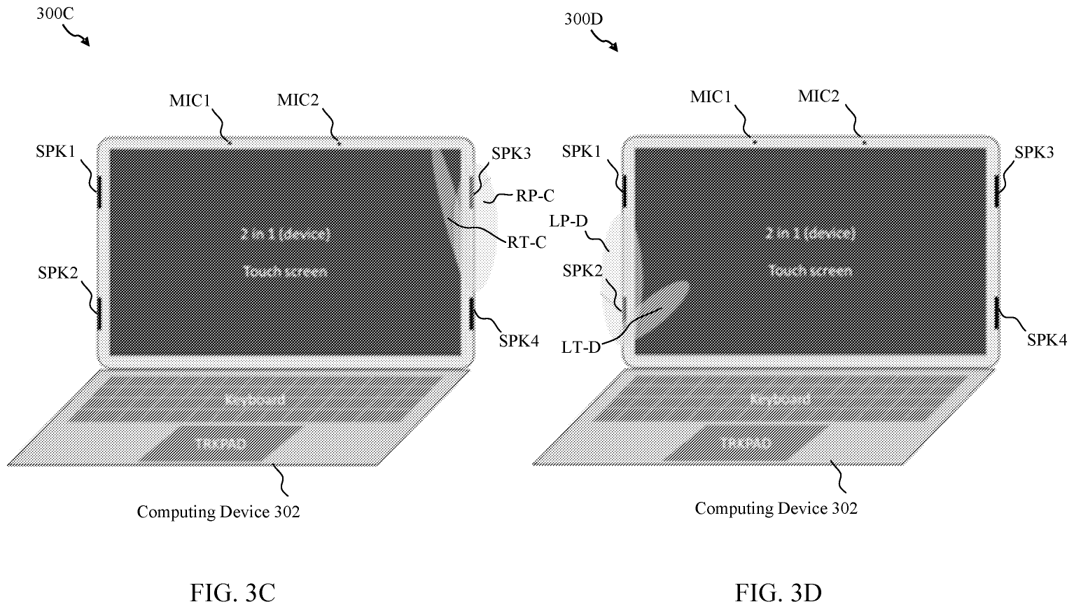

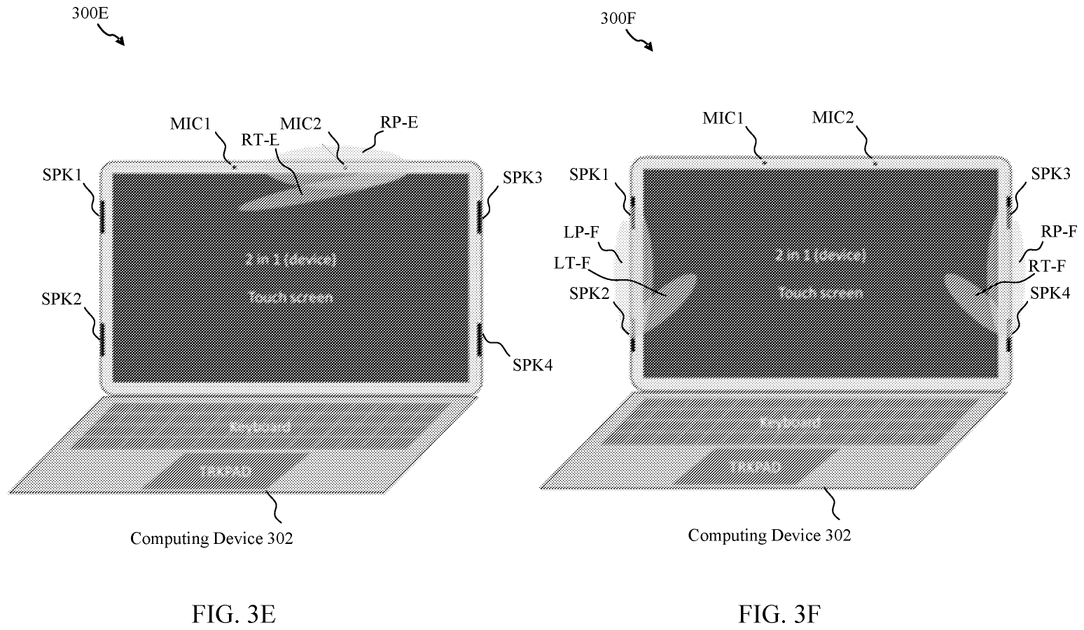

Heat map analyzer 124 may (e.g., when selected by grip analyzer 126 to perform an analysis) process heat map 238 generated by digitizer 108. Heat map analyzer 124 may provide grip determiner 130 with screen touch indication 250, indicating whether and/or where a user's hand touches areas of touch screen 106. FIGS. 3A-3F show some examples of user grips of computing device 102 where a user's palm and/or fingers touch touch screen 106.

Audio analyzer 128 may (e.g., when selected by grip analyzer 126 to perform an analysis) process signals generated by microphone(s) 134, e.g., first microphone 134A and/or second microphone 134B. Audio analyzer 128 may comprise, for example, audio broadcast signal selector 246 and audio response signal measurer 248. Audio analyzer 128 may have multiple modes. A first mode may be a transmit-receive mode involving driving speaker(s) 136, such that signals generated by microphone(s) 134 are predominantly based on the sound waves generated by speaker(s) 136 (e.g., first, second, third, and/or fourth speakers 134A-134D). A second mode may be a listen mode without driving speaker(s) 136, such that signals generated by microphone(s) 134 are predominantly noise (e.g., vibrations caused by sound waves caused by a user and/or the environment).

In the first mode (e.g., an audio echo mode), audio broadcast signal selector 246 may select and provide signal(s) representative of acoustic wave(s) for audio driver 240 to drive, causing one or more speaker(s) 136 may drive the acoustic wave(s). The acoustic wave(s) may be ultrasonic or otherwise inaudible to user.

In some examples, audio broadcast signal selector 246 may select one or more signals (e.g., a set of signals. The signal(s) may be provided to audio driver 240 simultaneously so that audio driver 240 simultaneously drives multiple speakers 136 with different signals, simultaneously generating different acoustic waves. The different acoustic waves may be, for example, the same signal with a frequency shift. Audio response signal measurer 248 may process signals generated by microphone(s) 134 based on the simultaneous acoustic waves.

In some examples, audio broadcast signal selector 246 may provide signal(s) audio driver 240 so that audio driver 240 drives multiple speakers 136 with the same signal at different times (e.g., based on a delay between transmissions), generating the same acoustic wave from different speakers at different times. The delay may be insignificant in terms of human movements, e.g., so that the successive waveforms occur for essentially the same position of a user's hands. Audio response signal measurer 248 may process signals generated by microphone(s) 134 based on the successive acoustic waves.

In the second mode, audio analyzer 128 may not use audio broadcast signal selector 246, audio driver 240, and speaker(s) 136. Microphone(s) 134 may generate signals based on noise. Signals generated by microphone(s) 134 based on acoustic waves or noise may indicate the presence or absence of user's palms and/or fingers relative to the chassis of computing device 102. Audio processor 242 may process noise signals generated by microphone(s) 134, providing the processed noise signals to audio response signal measurer 248.

Audio response signal measurer 248 may receive processed microphone signals from audio processor 242. Audio response signal measurer 248 may generate a chassis touch indication 252 indicating positions that user may be touching the chassis of computing device 102. For example, audio response signal measurer 248 may compare measured/signal data received from audio processor 242 to empirical data to determine chassis touch indication 252. In some examples, audio response signal measurer 248 may apply input data received from audio processor 242 to a machine learning (ML) model or a look up table (LUT) to predict or identify chassis touch indication 252. The acoustic waves detected by microphone(s) 134 may be impacted by the presence of user's palm and/or fingers on or near speaker(s) 136 and/or microphone(s) 134. Logic to determine a user grip style may be based on detection of blocked acoustic wave(s). For example, if a user covers a speaker the signal(s) generated by microphone(s) 134 based on the acoustic waveform from the covered speaker may indicate the waveform is suppressed or dampened. If a user covers a microphone, the signal(s) generated by microphone(s) 134 based on the acoustic waveforms from multiple (e.g., all) speakers may indicate the multiple waveforms are suppressed or dampened.

Audio response signal measurer 248 and/or audio analyzer 128 may identify a subtype of grip, such as a tight, loose, and/or very loose grip. Audio analyzer 128 may distinguish a subtype of grip, for example, based on signal levels (e.g., compared to empirical signal data). For example, a tight grip may cause high signal drops/blocks. A loose grip may cause lower signal drops/blocks. A very loose grip may cause echoes and/or amplification of an acoustic waveform, as may be indicated in the signal generated by microphone(s) 134 and processed by audio processor 242.

Motion analyzer 122 may perform multiple roles. Motion analyzer 122 may detect and indicate to trigger actuator 262 indications of motion based on signals generated by accelerometer 116 and/or gyro 118. Motion analyzer 122 may (e.g., alternatively or additionally) process signals generated by accelerometer 116 and/or gyro 118 to generate motion orientation indication 254 to assist grip determiner 130 with user grip determinations. For example, motion analyzer 122 may (e.g., when selected by grip analyzer 126 to perform an analysis) process signals generated by accelerometer 116 and/or gyro 118. Motion analyzer 122 may generate one or more indications regarding position, orientation, velocity, and acceleration of computing device 102. Motion information may assist with a grip determination and/or may be used to trigger a grip determination. For example, a signal generated by gyro 118 may indicate (e.g., alone or in combination with other signals) a touch position, such as which side a user grips computing device 102, based on three dimensional (3D) XYZ axes rotation information generated by gyro 118).

Grip determiner 130 may receive a chassis touch indication 252 from audio analyzer 128, a screen touch indication 250 from heat map analyzer 124, and/or a motion orientation indication 254 from motion analyzer 122. Grip determiner 130 may determine the grip type (e.g., or lack of grip) based on one or more of chassis touch indication 252, screen touch indication 250, and/or a motion orientation indication 254. A combination of chassis touch indication 252, screen touch indication 250, and/or a motion orientation indication 254 may provide a more complete understanding of user grip. As mentioned above, grip determiner 130 may make a grip determination based on input from any one of audio analyzer 128, heat map analyzer 124, or motion analyzer 122, though a grip determination based on inputs of two or more of audio analyzer 128, heat map analyzer 124, and/or motion analyzer 122, provides a more complete understanding of grip that may be used to better improve user experience in handling computing device 102. In some examples, grip determiner 130 may compare chassis touch indication 252, screen touch indication 250, and/or a motion orientation indication 254 to empirical values of chassis touch indication 252, screen touch indication 250, and/or a motion orientation indication 254 to determine (e.g., predict or select) a user grip type. In some examples, grip determiner 130 may apply chassis touch indication 252, screen touch indication 250, and/or a motion orientation indication 254 to a machine learning (ML) model or a look up table (LUT) to predict or identify a user grip.

Grip determiner 130 may determine and provide a grip type 256 to configuration selector 132. User grips may be categorized or grouped, for example, into grip types and subtypes. The number of types and subtypes of user grip may be based on, for example, association with empirical grip types and sub types that are associated with suitable grip configurations. Grip types may include no grip.

Configuration selector 132 may receive a grip determination from grip determiner 130. Configuration selector 132 may use the grip determination to select a grip configuration 258. Grip configuration 258 may be, for example, one or more grip configurations (e.g., a set of grip configurations) applicable to one or more components of computing device 102. Grip configuration 258 may be, for example, a process, an algorithm, a model, a set of parameters, a look up table, and so on, that may be deemed suitable for the user grip (e.g., an improvement compared to other configurations for the given user grip). Grip configuration 258 may be applicable to one or more components of computing device 102. For example, digitizer 108 and/or the OS may use the grip type 256 and/or the associated grip configuration 258 to determine whether and/or how to proceed with processing user touch, as indicated by signals generated by antenna array 110.

In some examples, a determined grip type 256 indicating that the user is or is not gripping a bezel or a portion of the touch screen and/or associated grip configuration 258 may cause digitizer 108 to add/or change portions of the heat map 238 so that portions of the heat map are not processed to determine user input. For example, a grip configuration 258 for digitizer 108 may cause digitizer 108 to block out a portion of antenna array 110 or heat map 238 from user input processing by digitizer 108 and/or by the OS (not shown).

In some examples, a determined grip type 256 indicating that the user is or is not gripping a bezel or a portion of the touch screen and/or associated grip configuration 258 may (e.g., also) cause the OS to reconfigure, rearrange, or relocate selectable icons displayed by display unit 104 away from the user grip, for example, to avoid accidental selection in the vicinity of where a user is touching touchscreen 106.

In some examples, a determined grip type 256 indicating that the user is or is not gripping a computing device 102 and/or associated grip configuration 258 may cause the digitizer 108 and/or OS to change (e.g., improve) touch performance, e.g., on the borders and/or core/central area of touch screen 106. Different grip configurations 258 may change touch performance related to acceptance/rejection of touch as intentional/unintentional based on whether and where a user touches computing device 102 (e.g., bezel, touch screen 106, chassis). In some examples, different grip configurations 256 may shift computing device 102 between tablet mode and other modes based on grip types 256. In some examples, different touch classifiers (e.g., ML models or algorithms) may be applied in different grip configurations 258 selected by configuration selector 132 based on whether computing device 102 is in grounded mode (e.g., plugged in) or ungrounded mode (e.g., not plugged in) and whether user is or is not gripping computing device 102 as the user interacts with (e.g., touches) touch screen 106. Signals generated by antenna array 110 for user touch in ungrounded mode may be lower than signals generated in ground mode.

In some examples, a determined grip type 256 indicating that the user is not gripping computing device 102 and/or associated grip configuration 258 may cause computing device 102 to increase device productivity, for example, because the temperature of computing device 102 may increase when a user is not touching computing device 102. This may lead to, for example, a ten percent (10%) increase in productivity.

In some examples, grip analyzer 126 may determine whether to activate heat map analyzer 124, audio analyzer 128, motion analyzer 122, and/or trigger actuator 262 based on the prevailing (e.g., current) grip configuration 258.

FIGS. 3A-3F show examples of detecting different user grip types, in accordance with an embodiment. FIGS. 3A-3F show examples where computing device 102 is a two-in-one (2-in-1) computing device 302 (e.g., notebook computer and tablet computer). Examples described are applicable to other types of computing devices. As shown in FIGS. 3A-3F, example 2-in-1 touch screen computing device 302 comprises four speakers (e.g., SPK1, SPK2, SPK3, SPK4), two microphones (e.g., MIC1, MIC2), three user input devices (e.g., keyboard, trackpad TRKPAD, touch screen), and sensors (e.g., not shown, such as accelerometer, gyro).

FIG. 3A shows an example 300A of computing device 302 without user grip. In example 300A, grip determiner 130 may determine that a user is not gripping computing device 302 based on one or more of chassis touch indication 252, screen touch indication 250, and/or a motion orientation indication 254. Chassis touch indication 252 may indicate a lack of touch because signals generated by MIC1 and MIC2 based on noise or acoustic waveform transmissions do not indicate user grip near MIC1, MIC2, SPKR1, SPKR2, SPKR3, or SPKR4. Screen touch indication 250 may indicate a lack of touch because heat map 238 does not show any user touch. Motion orientation indication 254 may indicate a lack of touch because signals generated by accelerometer 116 and gyro 118 do not indicate computing device 302 is in motion, or may indicate motion that doesn't indicate user grip (e.g., motion indicated computing device 302 is closed, moving as if being carried in a bag).

FIG. 3B shows an example 300B of computing device 302 where a user grips the lower right bezel and screen using the right hand. Example 300B shows user's right palm RP-B covering SPKR4, touching a lower portion of the bezel and touch screen 106 while user's right thumb RT-B touches the lower, mid and upper right portion of touch screen 106. In example 300B, grip determiner 130 may determine that a user is gripping the lower right bezel and screen of computing device 302 based on one or more of chassis touch indication 252, screen touch indication 250, and/or a motion orientation indication 254. Chassis touch indication 252 may indicate a user grips the lower right bezel and screen because signals generated by MIC1 and MIC2 based on noise or acoustic waveform transmissions indicate user grip near SPKR4. For example, signals generated by MIC1 and MIC2 based on an acoustic waveform emitted by SPKR4 may indicate the detected waveform is dampened relative to acoustic waveforms emitted by SPKR1, SPKR2, and SPKR3 and/or because signals generated by MIC1 and MIC2 are consistent with empirical signal patterns indicating a user gripping the lower right bezel and screen using the right hand covering SPKR4. Screen touch indication 250 may indicate a user grips the lower right bezel and screen using the right hand because heat map 238 shows a right palm and thumb pattern and/or because heat map 238 is consistent with an empirical heat map indicating a user gripping the lower right bezel and screen. Motion orientation indication 254 may indicate a user grips the lower right bezel and screen using the right hand because signals generated by accelerometer 116 and gyro 118 indicate one or more axes of rotation of computing device 302 at the lower right bezel and screen, or may not indicate user grip (e.g., if computing device 302 is on a desk).

FIG. 3C shows an example 300C of computing device 302 where a user grips the upper right bezel and screen using the right hand. Example 300C shows user's right palm RP-C covering SPKR3, touching an upper portion of the bezel and touch screen 106 while user's right thumb RT-C touches the upper right portion of touch screen 106 and bezel. In example 300C, grip determiner 130 may determine that a user is gripping the upper right bezel and screen of computing device 302 based on one or more of chassis touch indication 252, screen touch indication 250, and/or a motion orientation indication 254. Chassis touch indication 252 may indicate a user grips the upper right bezel and screen because signals generated by MIC1 and MIC2 based on noise or acoustic waveform transmissions indicate user grip near SPKR3. For example, signals generated by MIC1 and MIC2 based on an acoustic waveform emitted by SPKR3 may indicate the detected waveform is dampened relative to acoustic waveforms emitted by SPKR1, SPKR2, and SPKR4 and/or because signals generated by MIC1 and MIC2 are consistent with empirical signal patterns indicating a user gripping the upper right bezel and screen using the right hand covering SPKR3. Screen touch indication 250 may indicate a user grips the upper right bezel and screen using the right hand because heat map 238 shows a right palm and thumb pattern and/or because heat map 238 is consistent with an empirical heat map indicating a user gripping the upper right bezel and screen. Motion orientation indication 254 may indicate a user grips the upper right bezel and screen using the right hand because signals generated by accelerometer 116 and gyro 118 indicate one or more axes of rotation of computing device 302 at the upper right bezel and screen, or may not indicate user grip (e.g., if computing device 302 is on a desk).

FIG. 3D shows an example 300D of computing device 302 where a user grips the lower left bezel and screen using the left hand. Example 300D shows user's left palm LP-D covering SPKR2, touching a lower and middle left portion of the bezel and touch screen 106 while user's left thumb LT-D touches the lower left portion of touch screen 106. In example 300D, grip determiner 130 may determine that a user is gripping the lower left bezel and screen of computing device 302 based on one or more of chassis touch indication 252, screen touch indication 250, and/or a motion orientation indication 254. Chassis touch indication 252 may indicate a user grips the lower left bezel and screen because signals generated by MIC1 and MIC2 based on noise or acoustic waveform transmissions indicate user grip near SPKR2. For example, signals generated by MIC1 and MIC2 based on an acoustic waveform emitted by SPKR2 may indicate the detected waveform is dampened relative to acoustic waveforms emitted by SPKR1, SPKR3, and SPKR4 and/or because signals generated by MIC1 and MIC2 are consistent with empirical signal patterns indicating a user gripping the lower left bezel and screen using the left hand covering SPKR2. Screen touch indication 250 may indicate a user grips the lower left bezel and screen using the left hand because heat map 238 shows a left palm and thumb pattern and/or because heat map 238 is consistent with an empirical heat map indicating a user gripping the lower left bezel and screen. Motion orientation indication 254 may indicate a user grips the lower left bezel and screen using the left hand because signals generated by accelerometer 116 and gyro 118 indicate one or more axes of rotation of computing device 302 at the lower left bezel and screen, or may not indicate user grip (e.g., if computing device 302 is on a desk).

FIG. 3E shows an example 300E of computing device 302 where a user grips the top right bezel and screen using the right hand. Example 300E shows user's right palm RP-E covering MIC2, touching an top center portion of the bezel and touch screen 106 while user's right thumb RT-E touches the top center portion of touch screen 106. In example 300E, grip determiner 130 may determine that a user is gripping the top center bezel and screen of computing device 302 based on one or more of chassis touch indication 252, screen touch indication 250, and/or a motion orientation indication 254. Chassis touch indication 252 may indicate a user grips the top center bezel and screen, for example, because signals generated by MIC1 and MIC2 based on noise or acoustic waveform transmissions indicate user grip near MIC1. For example, signals generated by MIC1 based on an acoustic waveform emitted by SPKR1, SPKR2, SPKR3, and SPKR4 may indicate the detected waveform is dampened relative to signals generated by MIC2 based on an acoustic waveform emitted by SPKR1, SPKR2, SPKR3, and SPKR4 and/or because signals generated by MIC1 and MIC2 are consistent with empirical signal patterns indicating a user gripping the top center bezel and screen using the right hand covering MIC1. Screen touch indication 250 may indicate a user grips the top center bezel and screen using the left hand, for example, because heat map 238 shows a right palm and thumb pattern at the top center portion of touch screen 106 and/or because heat map 238 is consistent with an empirical heat map indicating a user gripping the top center bezel and screen. Motion orientation indication 254 may indicate a user grips the top center bezel and screen using the right hand because signals generated by accelerometer 116 and gyro 118 indicate one or more axes of rotation of computing device 302 at the top center bezel and screen, or may not indicate user grip (e.g., if computing device 302 is on a desk).

FIG. 3F shows an example 300F of computing device 302 where a user grips the lower right bezel and screen using the right hand and grips the lower left bezel and screen using the left hand. Example 300F shows user's right palm RP-F partially covering SPKR3 and SPKR4, touching a right center portion of the bezel and touch screen 106 while user's right thumb RT-F touches the right lower-mid portion of touch screen 106. Example 300F also shows user's left palm LP-F partially covering SPKR1 and SPKR2, touching a left center portion of the bezel and touch screen 106 while user's left thumb LT-F touches the left lower-mid portion of touch screen 106. In example 300F, grip determiner 130 may determine that a user is gripping the right and left center portions of the bezel and screen of computing device 302 based on one or more of chassis touch indication 252, screen touch indication 250, and/or a motion orientation indication 254. Chassis touch indication 252 may indicate a user grips the right and left center portion of bezel and screen because signals generated by MIC1 and MIC2 based on noise or acoustic waveform transmissions indicate user grip near SPKR1, SPKR2, SPKR3, and SPKR4. For example, signals generated by MIC1 and MIC2 based on acoustic waveforms emitted by SPKR1, SPKR2, SPKR3, and SPKR4 may indicate all four detected waveforms are dampened and/or because signals generated by MIC1 and MIC2 are consistent with empirical signal patterns indicating a user gripping the right and left center portions of the bezel and screen using the right hand covering SPKR3 and SPKR4 and the left hand covering SPKR1 and SPKR2. Screen touch indication 250 may indicate a user grips the right and left center portions of the bezel and screen using the right and left hands, for example, because heat map 238 shows a right palm and thumb pattern and a left palm and thumb pattern and/or because heat map 238 is consistent with an empirical heat map indicating a user gripping the right and left center portions of the bezel and screen. Motion orientation indication 254 may indicate a user grips the right and left center portions of the bezel and screen using the right and left hands because signals generated by accelerometer 116 and gyro 118 indicate one or more axes of rotation of computing device 302 in a (e.g., horizontal) line across the screen, or may not indicate user grip (e.g., if computing device 302 is on a desk).

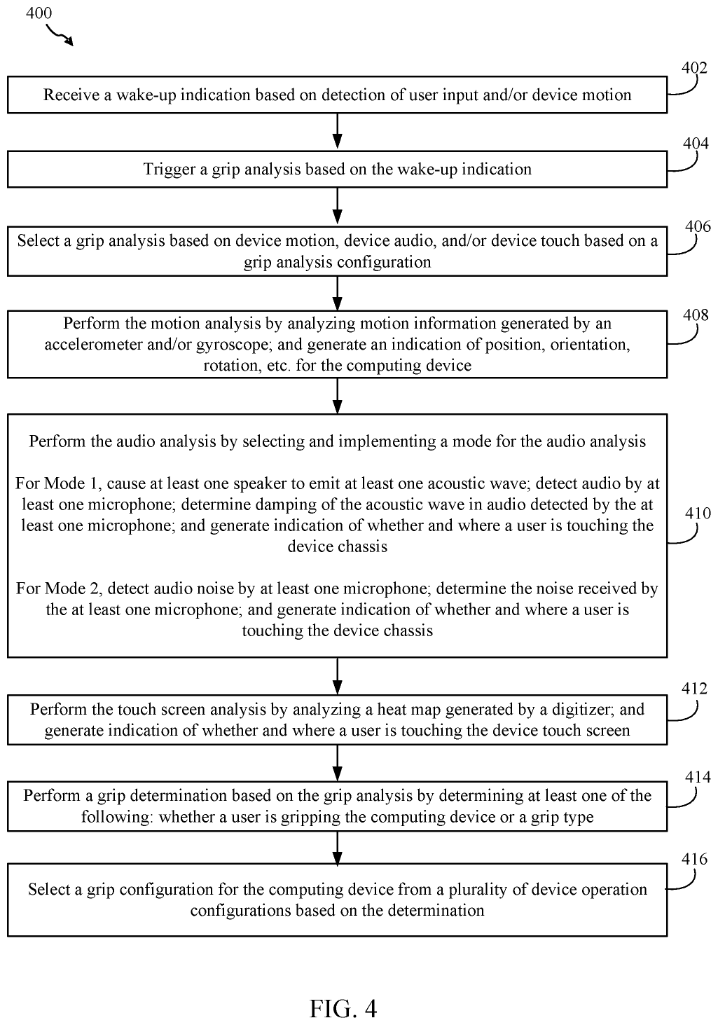

FIG. 4 shows a flowchart 400 of a process for implementing performance enhancement based on user grip, in accordance with an embodiment. Computing device 102, as shown by examples in FIGS. 1, 2, 3A-3F, and 6 may operate according to flowchart 400 at least in some embodiments. Example process 400 may be implemented, for example, by grip analyzer 126, grip determiner 130, and configuration selector 132, e.g., with assistance from the operating system, input devices, sensors, transducers, and/or other components of computing device 102. Various embodiments may implement one or more steps shown in FIG. 4 with additional and/or alternative steps. Further structural and operational embodiments will be apparent to persons skilled in the relevant art(s) based on the following description of FIG. 4.

In step 402, a wake-up indication is received. The wake-up indication may be based on detection of user input and/or device motion. For example, as shown in FIG. 2, grip analyzer 126 may be in a dormant or sleep state. Grip analyzer 262 may receive a wake-up indication from trigger actuator 262. The wake-up indication may be based on motion detected by motion analyzer 122 and/or by input detected from keyboard/mouse 220A and/or trackpad 220B.

In step 404, a grip analysis is triggered based on the wake-up indication. For example, as shown in FIG. 2, grip analyzer 126 may trigger a grip analysis based on the wake-up indication from trigger actuator 262.

In step 406, a grip analysis is selected based on device motion, device audio, and/or device touch based on a grip analysis configuration (e.g., existing grip configuration). For example, as shown in FIGS. 1 and 2, grip analyzer 126 may select one or more grip-related analyses (e.g., motion analysis, audio analysis, and/or touch screen analysis) be performed based on a configuration, such as prevailing grip configuration 258.

In step 408, the motion analysis is performed (e.g., if selected) by analyzing motion information generated by an accelerometer and/or gyroscope; and generate an indication of position, orientation, rotation, etc. for the computing device. For example, as shown in FIGS. 1 and 2, motion analyzer 122 may analyze signals generated by accelerometer 116 and gyro 118. Motion analyzer 122 may generate motion orientation indication 254, indicating the position, orientation, rotation, etc., for computing device 102.

In step 410, the audio analysis is performed (e.g., if selected) by selecting and implementing a mode for the audio analysis (e.g., mode 1, mode 2). In Mode 1, at least one speaker may be driven to emit at least one acoustic wave (e.g., sequentially or simultaneously). Audio may be detected by at least one microphone. Audio analysis may determine damping of the acoustic wave in the audio detected by the at least one microphone. An indication of whether and where a user is touching the device chassis may be generated. In Mode 2, audio noise may be detected by at least one microphone. The noise received by the at least one microphone may be determined. An indication of whether and where a user is touching the device chassis may be generated. For example, as shown in FIGS. 1, 2, and 3A-3F, audio analyzer 128 may perform an audio analysis using a configured mode. In Mode 1, audio broadcast signal selector 246 may select one or more signals for audio driver 240 to drive one or more speakers 136 to generate one or more acoustic waves. Microphone(s) 134 detect the acoustic waves by converting the detected vibrations into electrical signals, which are processed by audio processor 242 and analyzed by audio response signal measurer 248. As shown in FIGS. 3A-3F, detected acoustic waves may be dampened, indicating the locations of user palms and fingers. Audio analyzer 128 may generate chassis touch indication 252, indicating whether and where a user is touching the device chassis based on the analysis by audio response signal measurer 248. In Mode 2, microphone(s) 134 detect noise by converting detected vibrations into electrical signals, which are processed by audio processor 242 and analyzed by audio response signal measurer 248. Audio analyzer 128 may generate chassis touch indication 252, indicating whether and where a user is touching the device chassis based on the analysis by audio response signal measurer 248.

In step 412, the touch screen analysis is performed (e.g., if selected) by analyzing a heat map generated by a digitizer. An indication of whether and where a user is touching the device touch screen may be generated. For example, as shown in FIGS. 1, 2, and 3A-3F, heat map analyzer 124 may analyze heat map 238 produced by digitizer 108. Heat map analyzer 124 may generate a screen touch indication 250 indicating whether and where a user is touching the device touch screen, such as shown in FIGS. 3A-3F.

In step 414, a grip determination is performed based on the grip analysis by determining at least one of the following: whether a user is gripping the computing device or a grip type. For example, as shown in FIGS. 1 and 2, grip determiner 130 may determine the presence or lack of grip, and/or the grip type based on one or more of chassis touch indication 252, screen touch indication 250, and/or a motion orientation indication 254. Grip determiner 130 may report the grip type 256 to configuration selector 132.

In step 416, a grip configuration is selected for the computing device from a plurality of device operation configurations based on the determination (e.g., map grip type to a suitable grip configuration). For example, as shown in FIGS. 1 and 2, configuration selector 132 may use the grip determination to select a grip configuration 258.

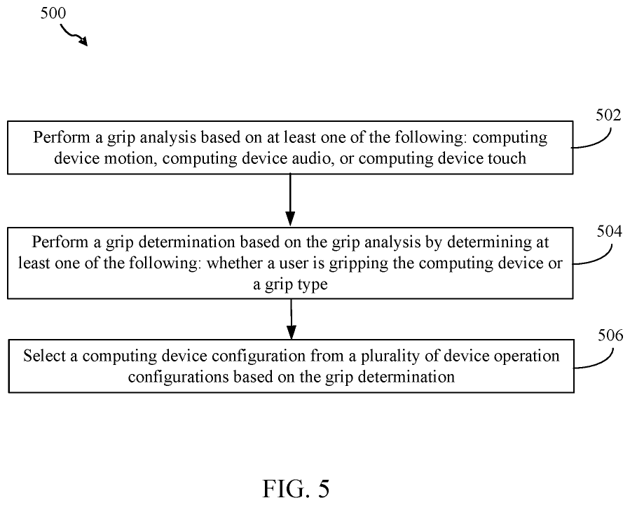

FIG. 5 shows a flowchart 500 of a process for implementing performance enhancement based on user grip, in accordance with an embodiment. Computing device 102, as shown by examples in FIGS. 1, 2, 3A-3F, and 6 may operate according to example process 500, e.g., at least in some embodiments. Example process 500 may be implemented, for example, by grip analyzer 126, grip determiner 130, and configuration selector 132, e.g., with assistance from the operating system, input devices, sensors, transducers, and/or other components of computing device 102. Various embodiments may implement one or more steps shown in FIG. 5 with additional and/or alternative steps. Further structural and operational embodiments will be apparent to persons skilled in the relevant art(s) based on the following description of FIG. 5.

In step 502, a grip analysis may be performed based on at least one of the following: computing device motion, computing device audio, or computing device touch. For example, as shown in FIGS. 1 and 2, grip analyzer 126 may select one or more grip-related analyses (e.g., motion analysis, audio analysis, and/or touch screen analysis) be performed based on a configuration, such as prevailing grip configuration 258. The grip analysis may be performed on any one or combination of motion of computing device 102 (“computing device motion”), audio/sound produced by computing device 102 (“computing device audio”), and/or touch with respect to computing device 102 (“computing device touch”), as described elsewhere herein.

In step 504, a grip determination may be performed based on the grip analysis by determining at least one of the following: whether a user is gripping the computing device or a grip type. For example, as shown in FIGS. 1 and 2, grip determiner 130 may determine the presence or lack of grip, and/or the grip type based on one or more of chassis touch indication 252, screen touch indication 250, and/or a motion orientation indication 254. Grip determiner 130 may report the grip type 256 to configuration selector 132.

In step 506, a computing device configuration may be selected from a plurality of device operation configurations based on the determination. For example, as shown in FIGS. 1 and 2, configuration selector 132 may use the grip determination to select a grip configuration 258.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code (program instructions) configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of computing device 102 of FIG. 1, which may include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows.

Computing device 602 can be any of a variety of types of computing devices. For example, computing device 602 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Quest 2® of Reality Labs, a division of Meta Platforms, Inc., etc.), or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing one or more of grip analyzer 126, grip determiner 130, and/or configuration selector 132, grip configuration system 200, along with any components and/or subcomponents thereof, as well as the flowcharts/flow diagrams (e.g., flowcharts 400 and/or 500) described herein, including portions thereof, and/or further examples described herein.

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform such as Amazon Web Services® of Amazon Web Services, Inc., or Google Cloud Platform™ of Google LLC, although these are only examples and are not intended to be limiting.

In an embodiment, computing device 602 may access application programs 676 for execution in any manner, such as by a client application and/or a browser at computing device 602. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### V. Additional Example Embodiments

Systems, methods, and instrumentalities are described herein related to device performance enhancements based on user grip. Device performance is controlled by adaptation of device or component configurations to detected user grip. The device may detect that a user is or is not gripping a device and/or a particular user grip type (e.g., grip style, grip position, grip side). User grip may be determined based on analyses of motion (e.g., indicated by accelerometer or gyro), chassis touch (e.g., indicated by microphone(s)), and/or screen touch (e.g., indicated by digitizer). A chassis touch analysis may be performed using multiple modes with or without generating acoustic waves through speakers to detect palm and finger placement near speakers and/or microphones. A chassis touch analysis may be implemented alone or in conjunction with a touch screen analysis for a more complete understanding of user grip. User grip may be matched with a suitable grip configuration for the device or one or more components thereof. For example, a no touch configuration may increase device productivity since the device temperature may rise without user contact. Signals generated by antenna array 110 for user touch in ungrounded mode may be lower than signals generated in ground mode. A determination that the user grips the device may be used as an indication that the device is grounded (through the user to the Earth), which can be used to select a grounded grip configuration for the device with improved device operation while grounded (e.g., utilize the higher amplitude signals produced by touch in antenna array 110). A screen bezel touch configuration may reconfigure displayed icons to avoid unintentional selection. Grip detection may be triggered (e.g., based on motion of input detection) to conserve power.

In an example, a computing device comprises: a processor; and a memory device that stores program code configured to be executed by the processor, the program code comprising: a grip analyzer configured to perform a grip analysis on the computing device based on at least one of a computing device motion, a computing device audio, or a computing device touch; a grip determiner configured to determine, based on the grip analysis, at least one of whether a user grips the computing device or a grip type applied by the user to the computing device; and a configuration selector configured to select a computing device configuration from a plurality of computing device operation configurations based on the determination.

In examples, the system further comprises: at least one speaker; an audio broadcast signal selector configured to cause the at least one speaker to emit an acoustic wave; at least one microphone configured to detect the computing device audio caused by the acoustic wave; and an audio response signal measurer configured to determine an amount of damping of the acoustic wave received by the at least one microphone.

In examples, the audio broadcast signal selector is configured to cause a plurality of speakers to transmit the acoustic wave sequentially or simultaneously using different frequencies.

In examples, the system further comprises: at least one microphone configured to detect the computing device audio caused by noise; and an audio response signal measurer configured to determine the noise received by the at least one microphone.

In examples, the grip analyzer is configured to perform the grip analysis based on a combination of the computing device audio and the computing device touch.

In examples, the grip analyzer is configured to perform the grip analysis based on a combination of the computing device audio, the computing device touch, and the computing device motion.

In examples, the grip analysis is triggered by the grip analyzer based on detection of a user input.

In examples, the grip analysis is triggered by the grip analyzer based on a detection of the computing device motion.

In examples, the configuration selector is configured to select a computing device configuration that increases computing device productivity in response to a determination by the grip determiner that the user is not gripping the computing device.

In examples, the configuration selector is configured to select a computing device configuration that moves displayed selectable icons away from a user grip in response to a determination by the grip determiner that the user grips at least one of a bezel or a portion of a touch screen of the computing device.

In examples, the configuration selector is configured to select a computing device configuration that changes touch detection in response to a determination by the grip determiner that the user grips at least one of a bezel or a portion of a touch screen of the computing device.

In another example, a method in a computing device comprises: performing a grip analysis on the computing device based on at least one of a computing device motion, a computing device audio, or a computing device touch; performing a grip determination, based on the grip analysis, by determining at least one of whether a user grips the computing device or a grip type applied by the user to the computing device; and selecting a computing device configuration from a plurality of computing device operation configurations based on the grip determination.

In examples, the performing the grip analysis based on at least the computing device audio comprises detecting, by at least one computing device microphone, the computing device audio caused by noise or an acoustic wave emitted by at least one computing device speaker; and at least one of: determining noise received by the at least one microphone, or determining an amount of damping of the acoustic wave received by the at least one microphone.

In examples, the performing the grip analysis comprises: performing the grip analysis based on a combination of at least two of the computing device audio, the computing device touch, or the computing device motion.

In examples, the selecting comprises: selecting a computing device configuration that increases computing device productivity in response to a determination that the user does not grip the computing device.

In examples, the selecting comprises: selecting a computing device configuration that moves displayed selectable icons away from a user grip in response to a determination that the user grips at least one of a bezel or a portion of a touch screen of the computing device.

In examples, the selecting comprises: selecting a computing device configuration that changes touch detection in response to a determination that the user grips at least one of a bezel or a portion of a touch screen of the computing device.

In another example, a computer-readable storage medium has program instructions recorded thereon that, when executed by a processor, implements a method comprising: performing a grip analysis on the computing device based on at least one of a computing device motion, a computing device audio, or a computing device touch; performing a grip determination, based on the grip analysis, by determining at least one of whether a user grips the computing device or a grip type applied by the user to the computing device; and selecting a computing device configuration from a plurality of computing device operation configurations based on the grip determination.

In examples, the performing of the grip analysis based on at least the computing device audio comprises: detecting, by at least one computing device microphone, the computing device audio caused by noise or an acoustic wave emitted by at least one computing device speaker; and at least one of: determining noise received by the at least one microphone, or determining an amount of damping of the acoustic wave received by the at least one microphone.

In examples, the selection of the computing device configuration comprises at least one of: selecting a computing device configuration that increases computing device productivity in response to a determination that the user is not gripping the computing device; selecting a computing device configuration that moves displayed selectable icons away from a user grip in response to a determination that the user grips at least of a bezel or a portion of a touch screen of the computing device; or selecting a computing device configuration that changes touch detection in response to a determination that the user grips at least one of a bezel or a portion of a touch screen of the computing device.

### VI. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A computing device, comprising:
a processor; and
a memory device that stores program code configured to be executed by the processor to:
analyze audio produced by the computing device;
determine, based on the analysis of the audio produced by the computing device, at least one of whether a user grips the computing device or a grip type applied by the user to the computing device; and
select a computing device configuration from a plurality of computing device operation configurations based on the determination.

2. The computing device of claim 1, further comprising:
at least one speaker; and
at least one microphone configured to detect the audio produced by the computing device; and
wherein the program code is further configured to be executed by the processor to:
cause the at least one speaker to emit the audio produced by the computing device as an acoustic wave, and
subsequent to the microphone having detected the audio produced by the computing device, determine an amount of damping of the acoustic wave received by the at least one microphone.

3. The computing device of claim 2, wherein the program code is further configured to be executed by the processor to cause a plurality of speakers to transmit the acoustic wave sequentially or simultaneously using different frequencies.

4. The computing device of claim 1, further comprising:
at least one microphone configured to detect noise audio caused by noise; and
wherein the program code is further configured to be executed by the processor to determine the noise received by the at least one microphone.

5. The computing device of claim 1, wherein the program code is further configured to be executed by the processor to determine at least one of whether a user grips the computing device or a grip type applied by the user to the computing device based on:
the audio produced by the computing device; and
a computing device touch.

6. The computing device of claim 1, wherein the program code is further configured to be executed by the processor to determine at least one of whether a user grips the computing device or a grip type applied by the user to the computing device based on:
the audio produced by the computing device; and
a motion of the computing device.

7. The computing device of claim 1, wherein the program code is further configured to be executed by the processor to trigger the analysis of the audio produced by the computing device based on detection of a user input.

8. The computing device of claim 1, wherein the program code is further configured to be executed by the processor to trigger the analysis of the audio of the computing device based on a detection of a motion of the computing device.

9. The computing device of claim 1, wherein the program code is further configured to be executed by the processor to select a computing device configuration that increases computing device productivity in response to a determination that the user is not gripping the computing device.

10. The computing device of claim 1, wherein the program code is further configured to be executed by the processor to select a computing device configuration that moves displayed selectable icons away from a user grip in response to a determination that the user grips at least one of a bezel or a portion of a touch screen of the computing device.

11. The computing device of claim 1, wherein the program code is further configured to be executed by the processor to select a computing device configuration that changes touch detection in response to a determination that the user grips at least one of a bezel or a portion of a touch screen of the computing device.

12. A method in a computing device, comprising:
analyzing audio produced by the computing device;
performing a grip determination, based on the analysis of the audio produced by the computing device, by determining at least one of whether a user grips the computing device or a grip type applied by the user to the computing device; and
selecting a computing device configuration from a plurality of computing device operation configurations based on the grip determination.

13. The method of claim 12, wherein analyzing the audio produced by the computing device comprises:
detecting, by at least one computing device microphone, noise audio caused by noise or an acoustic wave emitted by at least one computing device speaker; and at least one of:
determining noise received by the at least one microphone, or
determining an amount of damping of the acoustic wave received by the at least one microphone.

14. The method of claim 12, wherein said determining at least one of whether a user grips the computing device or a grip type applied by the user to the computing device is based on:
the analysis of the audio produced by the computing device; and
a motion of the computing device.

15. The method of claim 12, wherein said selecting comprises:
selecting a computing device configuration that increases computing device productivity in response to a determination that the user does not grip the computing device.

16. The method of claim 12, wherein said selecting comprises:
selecting a computing device configuration that moves displayed selectable icons away from a user grip in response to a determination that the user grips at least one of a bezel or a portion of a touch screen of the computing device.

17. The method of claim 12, wherein said selecting comprises:
selecting a computing device configuration that changes touch detection in response to a determination that the user grips at least one of a bezel or a portion of a touch screen of the computing device.

18. A computer-readable storage device having program instructions recorded thereon that, when executed by a processor, implements a method comprising:
analyzing audio produced by the computing device;
performing a grip determination, based on the analysis of the audio produced by the computing device, by determining at least one of whether a user grips the computing device or a grip type applied by the user to the computing device; and
selecting a computing device configuration from a plurality of computing device operation configurations based on the grip determination.

19. The computer-readable storage device of claim 18, wherein analyzing the audio produced by the computing device comprises:
detecting, by at least one computing device microphone, noise audio caused by noise or an acoustic wave emitted by at least one computing device speaker; and at least one of:
determining noise received by the at least one microphone, or
determining an amount of damping of the acoustic wave received by the at least one microphone.

20. The computer-readable storage device of claim 18, wherein the selection of the computing device configuration comprises at least one of:
selecting a computing device configuration that increases computing device productivity in response to a determination that the user is not gripping the computing device;
selecting a computing device configuration that moves displayed selectable icons away from a user grip in response to a determination that the user grips at least of a bezel or a portion of a touch screen of the computing device; or
selecting a computing device configuration that changes touch detection in response to a determination that the user grips at least one of a bezel or a portion of a touch screen of the computing device.
